(19) United States
(12) Patent Application Publication
(10) Pub. No.: US 2014/0347278 A1
(43) Pub. Date: Nov. 27, 2014

(54) SMARTPHONE

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: WU ZHOU, Shenzhen (CN); XIAO-GANG YIN, Shenzhen (CN)

(21) Appl. No.: 13/909,110

(22) Filed: Jun. 4, 2013

(30) Foreign Application Priority Data
May 21, 2013 (CN) 2013101880911

(51) Int. Cl. G06F 1/16

(52) U.S. Cl. CPC G06F 1/169
USPC 345/161

(57) ABSTRACT

A smartphone includes a base, a cover, and a joystick assembly. The base includes a bottom wall. The cover defines a through hole. The joystick assembly includes a fastening member, a receiving member mounted to the bottom wall, and a stick. The fastening member is slidably mounted to the cover. A bottom end of the stick is rotatably received in the receiving member. A top end of the stick extends out of the cover through the through hole and is capable of being moved. The fastening slides to latch with the stick, thereby fastening the stick.

### BACKGROUND

1. Technical Field

The present disclosure relates to a smartphone including a joystick.

2. Description of Related Art

Many smartphones use touch panels. However, when users want to play games, the touch panels may not be sensitive enough.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an embodiment of a smartphone which includes a cover.

FIG. 2 is a side plan view of the cover of FIG. 1.

FIGS. 3 to 5 are partially assembled views of FIG. 1, with some parts omitted.

FIG. 6 is an assembled, isometric view of FIG. 1.

FIG. 7 is a cross-sectional view of FIG. 6, taken along the line VII-VII.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

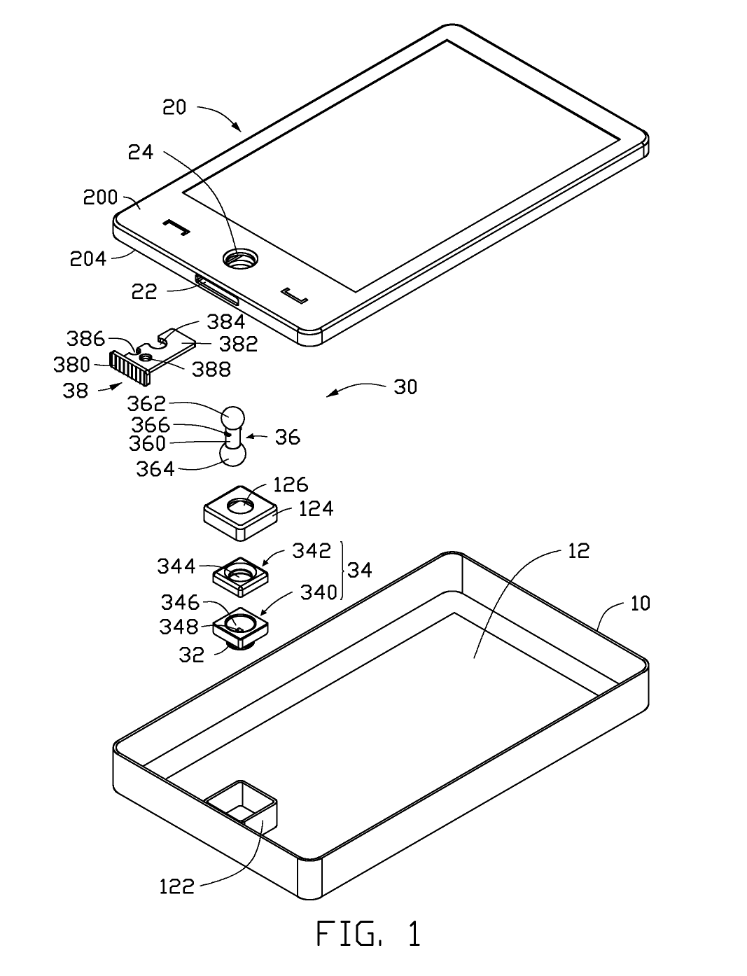

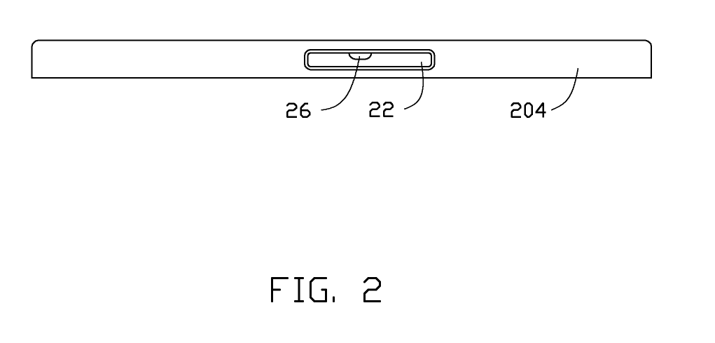

FIGS. 1 and 2 show an embodiment of a smartphone. The smartphone includes a base 10, a cover 20, and a joystick assembly 30.

The base 10 includes a bottom wall 12 forming a frame 122 adjacent to an end of the bottom wall 12, and a covering portion 124 detachably mounted to the frame 122. The covering portion 124 defines a first hole 126.

The cover 20 includes a top wall 200 and an end wall 204 perpendicularly connected to an end of the top wall 200. The end wall 204 defines a slide slot 22. The top wall 200 defines a through hole 24 communicating with the slide slot 22. A hemispherical protrusion 26 protrudes from a top surface bounding the slide slot 22.

The joystick assembly 30 includes a spring 32 having a bottom end supported on the bottom wall 12, a receiving member 34 mounted to a top end of the spring 32 opposite to the bottom wall 12, a stick 36, and a fastening member 38.

The receiving member 34 includes a holding portion 340 connected to the spring 32, and a sealing portion 342 detachably mounted to the holding portion 340. The sealing portion 342 defines a second hole 344, and a lower portion of the second hole 344 is hemispherical. A hemispherical recess 346 is defined in a top surface of the holding portion 340. A sensor 348 electrically connected a circuit board (not shown) of the smartphone is received in the recess 346.

The stick 36 includes a pole 360, and a round operation portion 362 and a round positioning portion 364 connected to opposite ends of the pole 360. The diameter of the operation portion 362 is greater than the diameter of the pole 360. The diameter of the positioning portion 364 is greater than the diameter of the operation portion 362. Two opposite pins 366 protrude from a circumference of the pole 360, adjacent to the operation portion 362.

The fastening member 38 includes an operation piece 380 and a fastening piece 382 perpendicularly connected to a side of the operation piece 380. The fastening piece 382 defines a latching hole 384 and a cutout 386 both extending through an edge of the fastening piece 382 perpendicular to the operation piece 380. The cutout 386 is positioned between the latching hole 384 and the operation piece 380. An engaging hole 388 is defined in the fastening piece 382, adjacent to the cutout 386.

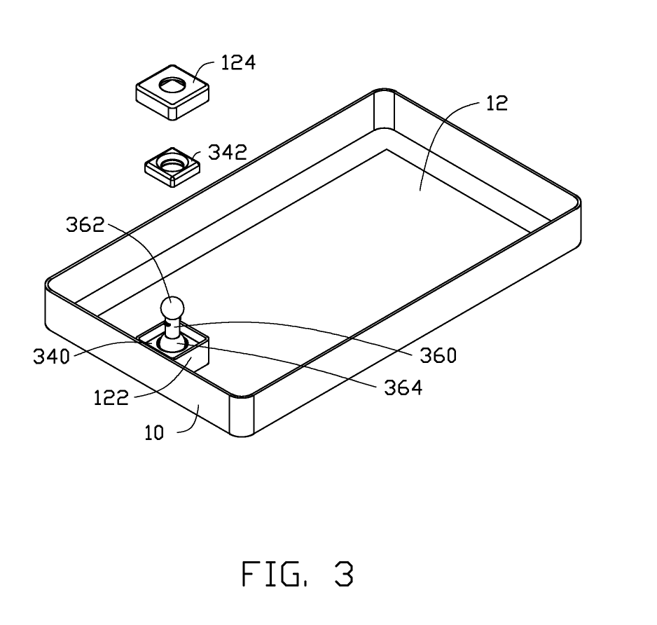

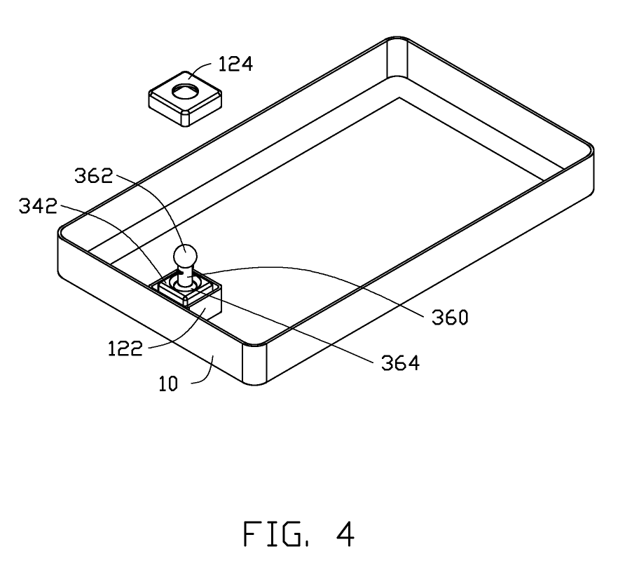

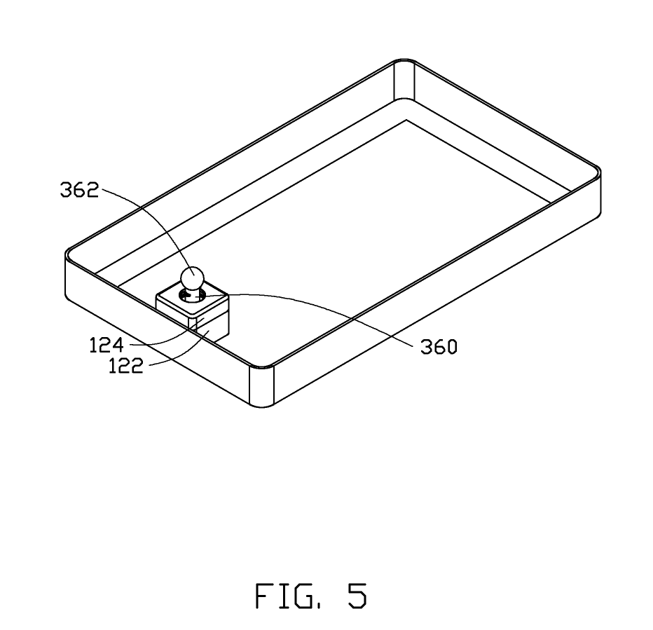

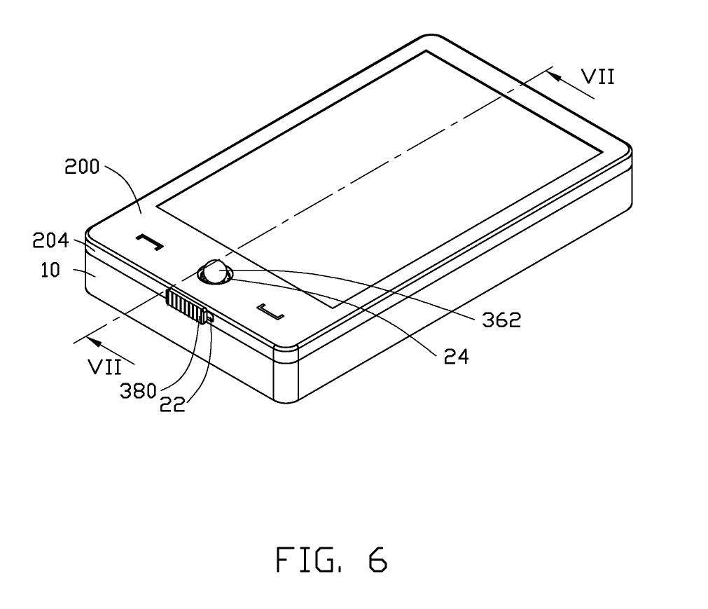

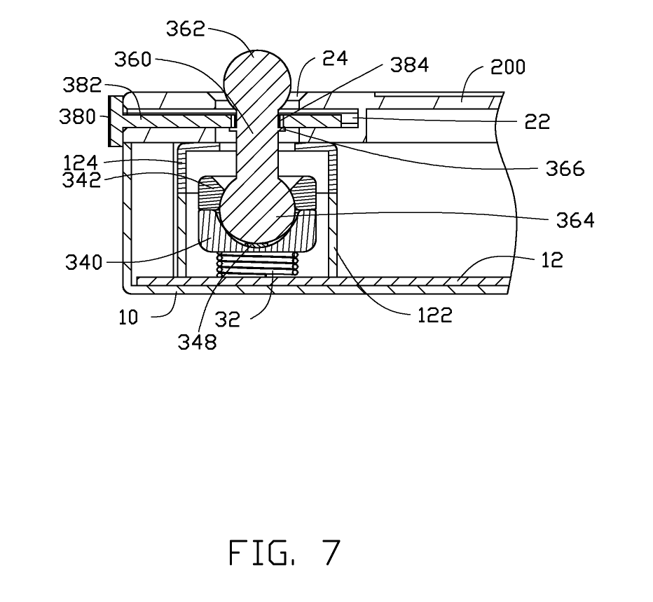

FIGS. 3 to 7 show that in assembly, the spring 32 and the holding portion 340 are received in the frame 122. The positioning portion 364 is received in the recess 346. The sealing portion 342 is mounted to the holding portion 340, to allow the operation portion 362 and the pole 360 to extend through the second hole 344. The positioning portion 364 is rotatably received in the receiving member 34. The covering portion 124 is then mounted to the frame 122, to allow the operation portion 362 and the pole 360 to extend through the first hole 126.

The fastening piece 382 extends into the slide slot 22, until the operation piece 380 abuts against an outer surface of the end wall 204. The protrusion 26 is engaged in the cutout 386, to fasten the fastening member 38. At this time, the fastening piece 382 is positioned beside the through hole 24.

The cover 20 is then mounted to the base 10. The operation portion 362 completely extends out of the through hole 24 and is capable of being manipulated to play games.

When the stick 36 does not need to be used, the operation portion 362 is pressed toward the base 10 and deforms the spring 32, to allow the operation portion 362 to be partly received in the through hole 24. The operation piece 380 is slid, to allow the pole 360 to engage in the latching hole 384. The pins 366 abut against a bottom of the fastening piece 382, thereby fastening the stick 36. The protrusion 26 is engaged in the engaging hole 388, to fasten the fastening member 38. In this state, the operation portion 362 cannot be used to play games.

It is believed that the present embodiments and their advantages will be understood from the foregoing description, and various changes may be made thereto without departing from the spirit and scope of the description or sacrificing all of their material advantages, the examples hereinbefore described merely being exemplary embodiments.

What is claimed is:

1. A smartphone, comprising:
a base comprising a bottom wall;
a cover defining a through hole and mounted to the base; and
a joystick assembly mounted to the bottom wall, and comprising a receiving member containing a sensor, a fastening member slidably mounted to the cover, and a stick; the stick having a bottom end rotatably received in the receiving member, and a top end extending out of the cover through the through hole of the cover and capable of being manipulated;
wherein the fastening member is capable of being slid to fasten the stick.

2. The smartphone of claim 1, wherein the joystick assembly further comprises a spring connected between the bottom wall and the receiving member, a pin extends from the stick, when the stick is pressed toward the bottom wall with deforming the spring, the top end of the stick partly withdraws into the cover, the pin of the stick moves to be blocked by a bottom of the fastening member.

3. The smartphone of claim 1, wherein the cover comprises a top wall and an end wall perpendicularly connected to an end of the top wall, the through hole is defined in the top wall, the end wall defines a slide slot communicating with the through hole, the fastening member comprises an operation piece slidable along the end wall and a fastening piece perpendicularly extending out from the operation piece and extending into the slide slot; the fastening piece defines a latching hole extending through an edge of the fastening piece to receive the stick.

4. The smartphone of claim 3, wherein the fastening piece defines an engaging hole, a protrusion protrudes from a top surface bounding the slide slot and engages in the engaging hole to fasten the fastening member in the top cover, in response to fasten the stick.

5. The smartphone of claim 4, wherein the fastening piece defines a cutout to fasten the protrusion in response to the stick being unfixed.

6. The smartphone of claim 3, wherein the stick comprises a pole to be engaged in the latching hole, two opposite pins protrude from a circumference of the pole and abut against a bottom of the fastening piece in response to fastening the stick.

7. The smartphone of claim 6, wherein the stick further comprises a round operation portion connected to a top end of the pole.

8. The smartphone of claim 7, wherein the stick further comprises a round positioning portion connected to a bottom end of the pole, the receiving member comprises a holding portion and a sealing portion detachably mounted to the holding portion, the holding portion defines a hemispherical recess, the sealing portion defines a hole, a lower portion of the hole is hemispherical, the positioning portion of the stick is received in the recess and the hole, the pole and the operation portion extend out of the sealing portion through the hole.

9. The smartphone of claim 7, wherein the bottom wall forms a frame and a covering portion detachably mounted to the frame, the holding portion is received in the frame, the covering portion defines a hole through which the operation portion and the pole of the stick extending through.
